(19) United States
(12) Patent Application Publication
(10) Pub. No.: US 2013/0066642 A1
(43) Pub. Date: Mar. 14, 2013

(54) SYSTEM AND METHOD FOR FACILITATING EXTENDED CARE PLANNING AND MANAGEMENT

(71) Applicant: Gennaro Luce, Avon, OH (US)

(72) Inventor: Gennaro Luce, Avon, OH (US)

(73) Assignee: Sequentia, Elyria, OH (US)

(21) Appl. No.: 13/229,263

(22) Filed: Sep. 9, 2011

(51) Int. Cl. G06Q 50/00

(52) U.S. Cl. 705/2

(57) ABSTRACT

Systems, methods, and non-transitory computer-readable media for facilitating extended care planning and management for patients. An interactive website is hosted on a server computer, where the interactive website provides a shared or common section being accessible to customers, hospitals, and extended care providers, a hospital-specific section being accessible to hospitals registered to the system, and an extended care provider (ECP)-specific section being accessible to registered ECP providers. A searchable database system is operatively connected to the server computer. The database system stores searchable listings of hospitals and ECPs which may be searched via the interactive website by users. The various sections of the website provide interactive capabilities, allowing various types of users of the website to become informed and to subsequently plan and manage the care they need or provide.

### TECHNICAL FIELD

Certain embodiments of the present invention relate to healthcare. More particularly, certain embodiments of the present invention relate to on-line systems and methods to facilitate extended care planning and management.

### BACKGROUND

Today, the U.S. healthcare delivery system consists of several interactive and interdependent processes that connect patients, families, doctors, nurses, technicians, specialized care and service providers, administrators, and insurance payors in a complex continuum of care. The primary goal of this continuum is to help ensure the best possible outcomes for all participants, especially the patient.

The army of people and resources that must be enlisted to care for a single patient requires a strong chain of command that can pass timely, accurate information from one process to the next and enable coherent, strategic and tactical care decisions that maintain and enhance the continuum. The increased voluntary and mandated use of information technology, such as billing automation and Electronic Medical Records (EMRs), has improved communication and streamlined logistics at many points along the decision-making chain. However, one of the weak links has always been the transition process between the hospital and what comes next on the continuum of care.

What comes next is usually a wide range of extended care options. The decision to select the precise option is absolutely critical to achieving optimal continuity of patient care, as well as the highest quality outcomes for all participants. The specific, even unique needs of the patient and the family drive the selection process. However, the sheer number of choices, each with different capability, suitability, and availability, can make this critical decision even more difficult. It often requires extensive research and consideration, as well as an educational dialogue between the hospital, the patient, and the family caregiver(s).

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

Embodiments of the present invention facilitate the on-line planning and management of extended care for patients.

An embodiment of the present invention comprises an internet-accessible system for facilitating extended care planning and management for patients. The system includes at least one server computer and an interactive website hosted on the server computer. The interactive website includes a shared or common section being accessible to customers, hospitals, and extended care providers. The interactive website also includes a hospital section being accessible to hospitals registered to the system. The interactive website further includes an extended care provider (ECP) section being accessible to extended care providers registered to the system. The system also includes at least one searchable database operatively connected to the at least one server computer and storing searchable listings of hospitals and extended care providers. The shared section may include computer-executable instructions configured to: facilitate the searching and comparing of ECPs via the internet; facilitate the searching and comparing of hospitals via the internet; facilitate the playing of digital media stored on the system via the internet; facilitate linking to other determined websites via the internet; facilitate the showcasing of comments of visitors to the interactive website via the internet; provide access to news stories stored on the system via the internet. The hospital section may include computer-executable instructions configured to: facilitate the creation of a hospital provider profile (using marketing tools), via the internet, which can be accessed by visitors to the interactive website; facilitate the searching and comparing of ECPs via the internet; facilitate the pre-certifying of patient medical conditions and insurance eligibility with one or more ECPs via the internet; facilitate the determining of the availability of services and facilities at one or more ECPs via the internet; facilitate the scheduling of services and the reserving of facilities at a selected ECP via the internet; facilitate the assembling and editing of patient electronic medical record (EMR) information; facilitate the secure, real-time transmission of the patient EMR information between a hospital computer and an ECP computer via the internet; facilitate the two-way communication of electronic notifications and information between a hospital computer and an ECP computer via the internet; facilitate the training of a hospital discharge planner via the internet. The ECP section may include computer-executable instructions configured to: facilitate the creation of an ECP provider profile (using marketing tools), via the internet, which can be accessed by visitors to the interactive website; facilitate the updating of available facility openings and care and service offerings of an ECP via the internet; facilitate the assembling and editing of patient electronic medical record (EMR) information; facilitate secure, real-time transmission of the patient EMR information between and ECP computer and a hospital computer via the internet; facilitate the two-way communication of electronic notifications and information between an ECP computer and a hospital computer via the internet; facilitate the training of ECP admissions coordinators and marketing personnel via the internet.

Another embodiment of the present invention comprises a non-transitory computer-readable medium having computer-executable instructions recorded thereon and capable of being executed by an internet-accessible server computer hosting an interactive website to facilitate extended care planning and management for patients. The instructions include instructions for the pre-certifying of patient medical conditions and insurance eligibility with one or more extended care providers (ECPs) via the internet. The instructions further include instructions for determining the availability of services and facilities at one or more ECPs via the internet, and instructions for scheduling services and reserving facilities at a selected ECP via the internet. The instructions may further include instructions for facilitating the searching and comparing of ECPs via the internet and instructions for facilitating the searching and comparing of hospitals via the internet. The instructions may also include instructions for facilitating the creation of a hospital provider profile, via the internet, which can be accessed by visitors to the interactive website. The instructions may also include instructions for facilitating the creation of an extended care provider profile, via the Internet, which can be accessed by visitors to the interactive website. The instructions may further include instructions for facilitating the assembling and editing of patient electronic medical record (EMR) information and for facilitating secure, real-time transmission of the patient EMR information between a hospital computer and an ECP computer via the internet. The instructions may further include instructions for facilitating the training of a hospital discharge planner via the internet, and instructions for facilitating the training of ECP admissions coordinators and marketing personnel via the internet.

Another embodiment of the present invention comprises a method to facilitate finding an extended care provider (ECP) for a patient. The method includes receiving patient information via the internet at an interactive website hosted on a server computer, from a remote computer system, for a patient to be admitted to an ECP facility. The remote computer system may be a hospital computer system located at a hospital, or a patient computer system operated by, for example, a patient or a friend or family member of the patient. The method also includes, sending a request for approval, on behalf of the patient, from the server computer via the Internet to one or more ECP computer systems of one or more ECP facilities. The method further includes receiving ECP approval information associated with the patient via the internet, at the interactive website, from at least one of the one or more ECP computer systems, wherein the ECP approval information indicates the acceptance of the patient by one or more of the ECP facilities based on a review of the patient information on the interactive website by the one or more ECP facilities. The method also includes sending at least one ECP acceptance communication from the server computer to the remote computer system via the internet, wherein the at least one ECP acceptance communication indicates the acceptance of the patient by one or more of the ECP facilities. The method may also include receiving patient acceptance information at the interactive website via the internet, corresponding to one of the ECP facilities, from the remote computer system, wherein the patient acceptance information indicates the acceptance of one of the ECP facilities by the patient. The method may further include sending a patient acceptance communication from the server computer to the one or more ECP systems via the internet, wherein the patient acceptance communication indicates the acceptance of an ECP facility by the patient. The patient information may include information extracted from an electronic medical record (EMR) of the patient. The patient information may include information identifying one or more ECP facilities selected by the patient. The method may further include receiving an ECP search request, having ECP search criteria, at the interactive website via the internet from the remote computer system. The method may also include performing a search of at least one searchable database operatively connected to the at least one server computer in response to the ECP search request, wherein the at least one searchable database stores searchable listings of ECP facilities. The method may further include sending search results from the server computer to the remote computer system via the internet, wherein the search results include information corresponding to ECP facilities that match the ECP search criteria.

A further embodiment of the present invention comprises a non-transitory computer-readable medium having computer-executable instructions recorded thereon and capable of being executed by an internet-accessible server computer hosting an interactive website to facilitate finding an extended care provider (ECP) for a patient. The instructions include instructions for receiving patient information via the internet at an interactive website hosted on a server computer, from a remote computer system, for a patient to be admitted to an ECP facility. The instructions further include instructions for sending a request for approval, on behalf of the patient, for the server computer via the Internet to one or more ECP computer systems of one or more ECP facilities. The instructions also include instructions for receiving ECP approval information associated with the patient via the internet, at the interactive website, from at least one of the one or more ECP computer systems, wherein the ECP approval information indicates the acceptance of the patient by one or more of the ECP facilities based on a review of the patient information on the interactive website by the one or more ECP facilities. The instructions further include instructions for sending at least one ECP acceptance communication from the server computer to the remote computer system via the internet, wherein the at least one ECP acceptance communication indicates the acceptance of the patient by one or more of the ECP facilities. The instructions may also include instructions for receiving patient acceptance information at the interactive website via the internet, corresponding to one of the ECP facilities, from the remote computer system, wherein the patient acceptance information indicates the acceptance of one of the ECP facilities by the patient. The instructions may further include instructions for sending a patient acceptance communication from the server computer to the one or more ECP computer systems via the internet, wherein the patient acceptance communication indicates the acceptance of an ECP facility by the patient. The instructions may also include instructions for receiving an ECP search request, having ECP search criteria, at the interactive website via the internet from the remote computer system. The instructions may further include instructions for performing a search of at least one searchable database operatively connected to the server computer in response to the ECP search request, wherein the at least one searchable database stores searchable listings of ECP facilities. The instructions may also include instructions for sending search results from the server computer to the remote computer system via the internet, wherein the search results include information corresponding to ECP facilities that match the ECP search criteria.

A further embodiment of the present invention comprises a system to facilitate the generation of revenue via an interactive website. The system includes an interactive website hosted on at least one server computer and maintained by a service provider, wherein the interactive website is configured to link patients and hospital entities to extended care provider (ECP) entities. The system also includes means for facilitating the development and hosting of a multimedia ECP profile on the interactive website by a registered ECP entity in exchange for a fee to be paid by the registered ECP entity to the service provider in accordance with a determined fee arrangement. The system further includes means for facilitating the development and hosting of a multimedia hospital profile on the interactive website by a registered hospital entity in exchange for a fee to be paid by the registered hospital entity to the service provider in accordance with a determined fee arrangement. The system may also include means for registering an ECP entity as a member of the interactive website and configuring the interactive website to be accessed by the registered ECP entity in exchange for a fee to be paid by the ECP entity to the service provider in accordance with a determined fee arrangement. The system may further include means for registering a hospital entity as a member of the interactive website and configuring the interactive website to be accessed by the registered hospital entity in exchange for a fee to be paid by the hospital entity to the service provider in accordance with a determined fee arrangement. The system may also include means for facilitating the assembling and editing of patient electronic medical record (EMR) information by a third party using the interactive website, and means for facilitating the secure, real-time transmission of the patient EMR information to the third party, in exchange for a fee to be paid by the third party to the service provider in accordance with a determined fee arrangement. The system may further include means for performing a preventative analysis for a registered ECP entity in exchange for a fee to be paid by the ECP entity to the service provider in accordance with a determined fee arrangement, wherein the preventative analysis identities at least one of improper charges to patients by the ECP entity, duplicate payments by patients to the ECP entity, mistakes by fiscal intermediaries on behalf of patients of the ECP entity, and medical necessity and coding errors of patients of the ECP entity. The system may also include means for performing a preventative analysis for a registered hospital entity in exchange for a fee to be paid by the hospital entity to the service provider in accordance with a determined fee arrangement, wherein the preventative analysis identifies at least one of improper charges to patients by the hospital entity, duplicate payments by patients to the hospital entity, mistakes by fiscal intermediaries on behalf of patients of the hospital entity, and medical necessity and coding errors of patients of the hospital entity. The system may further include means for posting an advertisement of an advertising entity to the interactive website in exchange for a fee to be paid by the advertising entity to the service provider in accordance with a determined fee arrangement.

Another embodiment of the present invention comprises a non-transitory computer-readable medium having computer-executable instructions recorded thereon and capable of being executed by an internet-accessible server computer hosting an interactive website to facilitate the generation of revenue via the interactive website. The instructions include instructions for facilitating the development and hosting of a multimedia ECP profile on the interactive website by a registered ECP entity of the interactive website in exchange for a fee to be paid by the registered ECP entity to a service provider of the website in accordance with a determined fee arrangement. The instructions also include instructions for facilitating the development and hosting of a multimedia hospital profile on the interactive website by a registered hospital entity of the interactive website in exchange for a fee to be paid by the registered hospital entity to the service provider of the website in accordance with a determined fee arrangement. The instructions may further include instructions for registering an ECP entity as a member of the interactive website and configuring the interactive website to be accessed by the registered ECP entity in exchange for a fee to be paid by the ECP entity to the service provider in accordance with a determined fee arrangement. The instructions may also include instructions for registering a hospital entity as a member of the interactive website and configuring the interactive website to be accessed by the registered hospital entity in exchange for a fee to be paid by the hospital entity to the service provider in accordance with a determined fee arrangement. The instructions may further include instructions for facilitating the assembling and editing of patient electronic medical record (EMR) information by a third party using the interactive website, and facilitating the secure, real-time transmission of the patient EMR information to the third party in exchange for a fee to be paid by the third party to the service provider in accordance with a determined fee arrangement. The instructions may also include instructions for performing a preventative analysis for a registered ECP entity in exchange for a fee to be paid by the ECP entity to the service provider in accordance with a determined fee arrangement, wherein the preventative analysis identifies at least one of improper charges to patients by the ECP entity, duplicate payments by patients to the ECP entity, mistakes by fiscal intermediaries on behalf of patients of the ECP entity, and medical necessity and coding errors of patients of the ECP entity. The instructions may further include instructions for performing a preventative analysis for a registered hospital entity in exchange for a fee to be paid by the hospital entity to the service provider in accordance with a determined fee arrangement, wherein the preventative analysis identifies at least one of improper charges to patients by the hospital entity, duplicate payments by patients to the hospital entity, mistakes by fiscal intermediaries on behalf of patients of the hospital entity, and medical necessity and coding errors of patients of the hospital entity.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a functional block diagram of an embodiment of a computer network environment including the internet and an extended-care planning and management system;

FIG. 2 illustrates a schematic block diagram of an embodiment of the extended-care planning and management system (PMS) of the computer network of FIG. 1;

FIG. 3 illustrates a functional block diagram of an embodiment of an interactive website hosted on at least one server computer of the extended-care planning and management system of FIG. 2;

FIG. 4 illustrates a functional block diagram of an embodiment of the shared or common section 400 of the interactive website of FIG. 3;

FIG. 5 illustrates a functional block diagram of an embodiment of the hospital-specific section of the interactive website of FIG. 3;

FIG. 6 illustrates a functional block diagram of an embodiment of the ECP-specific section of the interactive website of FIG. 3;

FIG. 7 is a flowchart of a first embodiment of a method to facilitate finding an extended care provider (ECP) for a patient, using the extended-care planning and management system of FIG. 1, from the point of view of the extended-care planning and management system of FIG. 1;

FIG. 8 is a flowchart of a second embodiment of a method to facilitate finding an extended care provider (ECP) for a patient, using the extended-care planning and management system of FIG. 1, from the point of view of a hospital;

FIG. 9 is a flowchart of a third embodiment of a method to facilitate finding an extended care provider (ECP) for a patient, using the extended-care planning and management system of FIG. 1, from the point of view of a patient; and

FIG. 10 is a flowchart of an embodiment of a method to facilitate the exchange of patient information between a hospital and an extended care provider (ECP).

### DETAILED DESCRIPTION

The term “computer”, as used herein, refers to a hardware platform having at least one processor, and which is programmed to execute software instructions (e.g., a personal computer or a workstation). The term “server computer”, as used herein, refers to a combination of hardware and software configured to run as a service on a network, to serve the needs or requests of other programs (i.e., clients) which may or may not be running on the same computer hardware. The term “section”, as used herein with respect to a website hosted on a server computer, refers to service-related elements of the website including but not limited to text, graphics, menus, interfaces, links, and computer-executable instructions. The term “software module” as used herein refers to a collection of functionally-related computer-executable instructions.

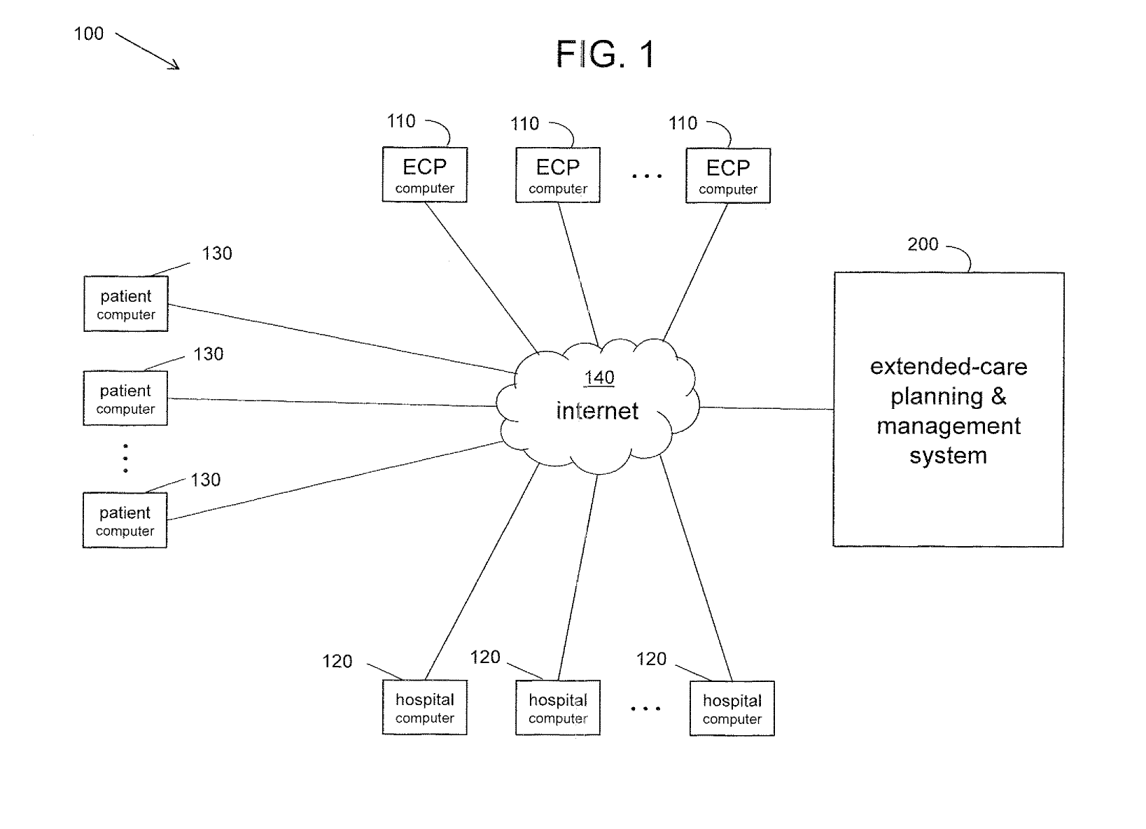

FIG. 1 illustrates a functional block diagram of an embodiment of a computer network 100 environment including the Internet and an extended-care planning and management system.

In general, computer network 100 services the healthcare industry by providing access to information from extended care providers (ECP), hospitals facilities, and patients or interested parties (customers) and integrating it into a searchable database. In one embodiment, the computer network 100 includes an extended care planning and management system (PMS) 200, and at least one remote computer. The remote computer, as showing in FIG. 1, may include at least one Hospital computer 120, at least one Patient computer 130, and at least one ECP computer 110. The ECP computer 110, hospital computer, patient computer 130 each communicate with the PMS 200 via a communications network, for example, the internet 140. Additional examples of communications networks could include a mobile broadband network, for example, Third or Fourth Generation (3G/4G) technology, a dedicated communication network, e.g., local area network (LAN) or wide area network (WAN) or transceivers capable of transmitting data to and from the PMS 200.

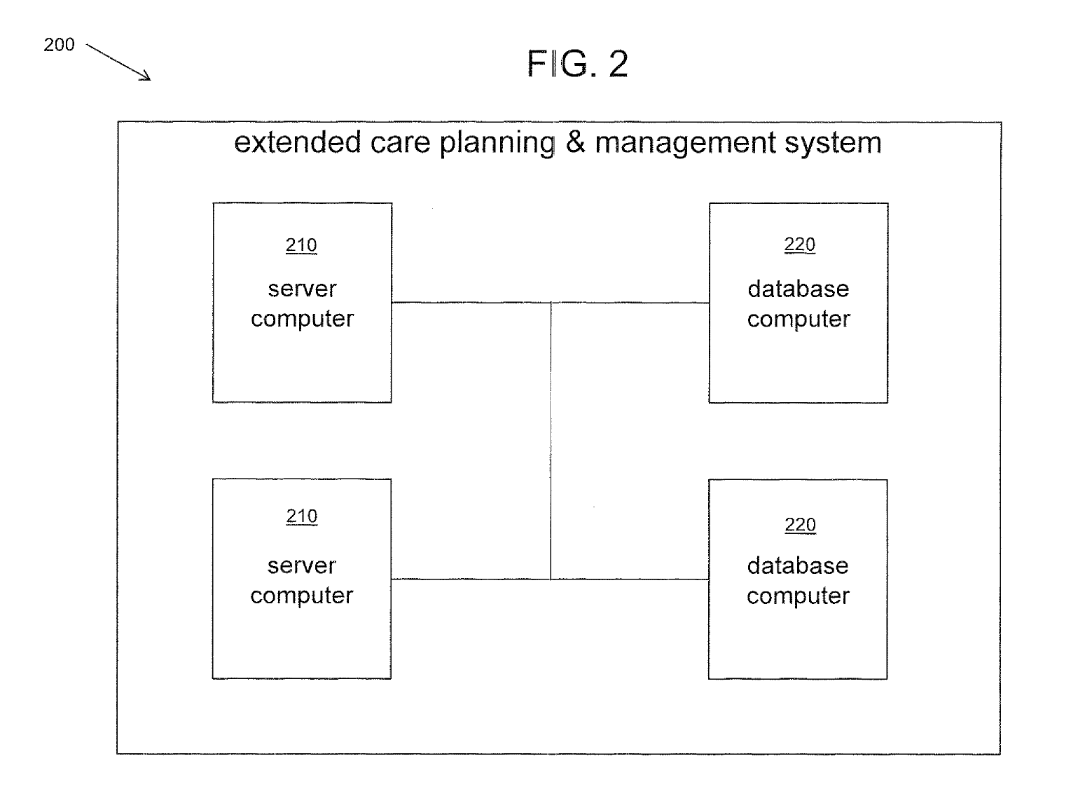

FIG. 2 illustrates a schematic block diagram of an embodiment of the extended-care planning and management system (PMS) 200 of the computer network 100 of FIG. 1.

The PMS 200 allows hospital and ECP administrative end-users to upload, modify and update text, images and other multimedia content. The PMS 200 also enables users to manage data within their dedicated sections via a dedicated or remote location. The PMS 200 may further include security measures for accessing information thereon by requiring password-protected logins or other secured connections known to persons of ordinary skill in the art. In one embodiment, the PMS 200 may includes at least a first server computer 210. The first server computer 210 may operatively communicate with at least a first database system 220. The database system 220 may reside on the first server 210, or may reside on a separate stand-alone computer. In the embodiment shown in FIG. 2, two server computers 210 are in communication with two database systems 220 residing on two stand-alone computers, for facilitating the transfer of information within the PMS 200. In a further embodiment, databases and server controls may reside on a single computer/server. The database 220 stores health system and hospital target prospects, ECP target prospects, along with a wide variety of information about the users of the PMS 200. To maintain security within the PMS 200, all hospital and ECP users may be required to register with the PMS 200, thereby establishing and using a secured login for accessing the PMS 200 servers. Users who do not register with the PMS 200 may also have access to the PMS 200, but such access may be limited, and restrict access to certain content within the PMS 200.

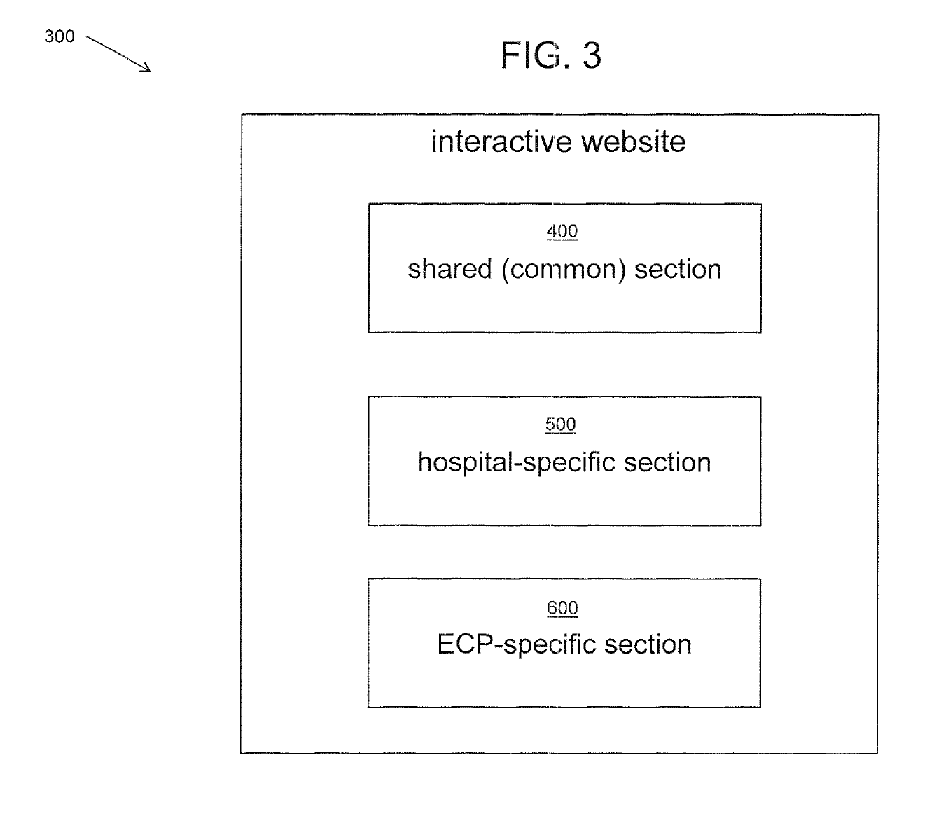

FIG. 3 illustrates a functional block diagram of an embodiment of an interactive website 300 hosted on at least one server computer 210 of the PMS 200 of FIG. 2.

The interactive website 300 hosted on the server computer 210 may include at least one section for accessing specific information within the PMS 200. In the embodiment shown in FIG. 2, the interactive website 300 includes a shared common section 400 generally accessible to all users (e.g., customers, hospitals and ECPs), a hospital-specific section 500 generally accessible to registered hospital end users, and an ECP-specific section 600 generally accessible to registered ECP end users. Additionally, the interactive website 300 may include a login command for allowing visitors to the interactive website 300 to register, or for providing registered users access to secured information specific to the user's profile created during the registration process, which will be discussed in further detail below.

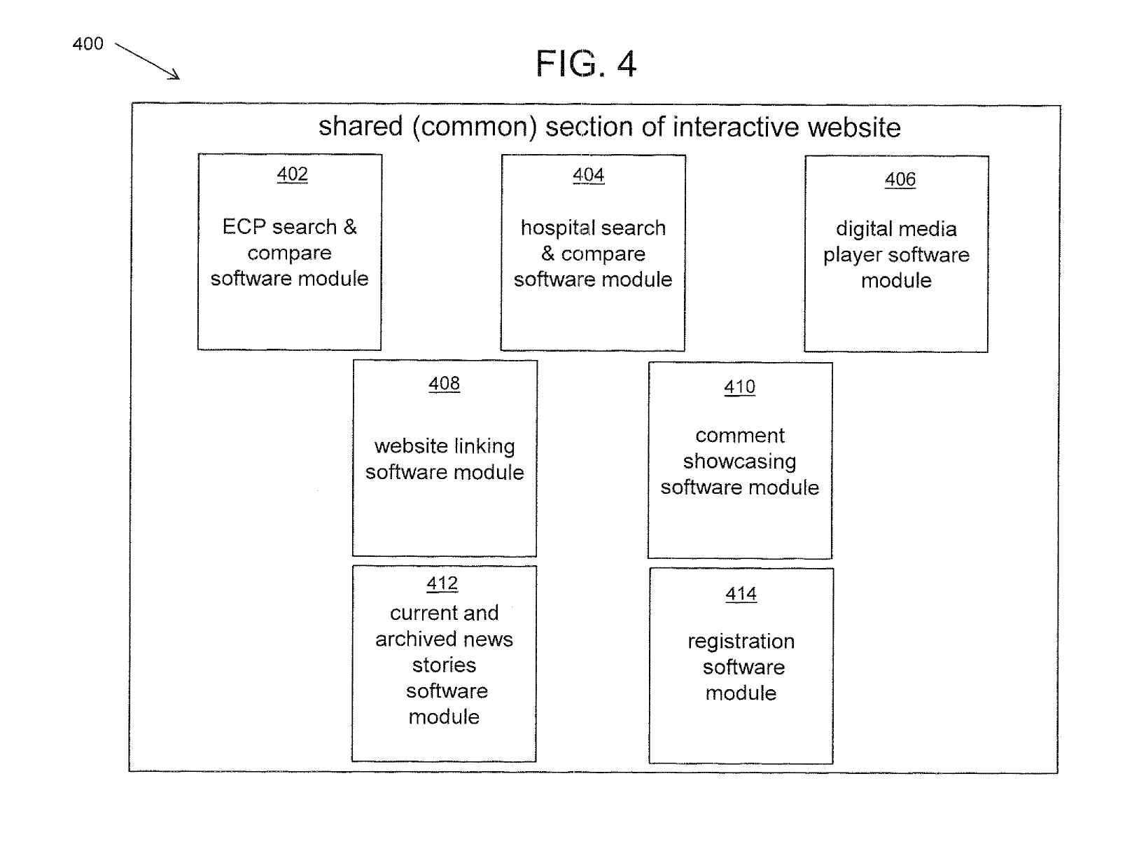

FIG. 4 illustrates a functional block diagram of an embodiment of the common section 400 of the interactive website of FIG. 3. The common section 400 is the shared section of the interactive website 300, and may include a set of common features and functionalities for all users. The common section 400 may include computer-executable instructions configured to facilitate the exchange of information between the end user and the PMS 200. An example of the computer-execuable instructions facilitating the exchange of information will now be discussed. In one embodiment, the common section 400 includes general and specific information about hospital facilities and ECPs. This information may include education information about all aspects of extend care treatment, e.g., medical conditions that may require extended care treatment, factors to considers when choosing an ECP, and how to compare and select among similar ECPs. Additionally, reviews, ratings or other information provided by persons familiar with specific ECPs or hospital facilities may be provided as part of the information in the common section 400 or other sections as will be discussed herein. The end user, wanting to retrieve information about ECPs, will then enter their search criteria specific to their needs, e.g., five (5) star rated ECPs. The computer-executable instructions will then process this search criteria by operatively communicating with the database system 220, and returning a listing of ECPs that have a five (5) star rating to the requester.

Additionally, in one embodiment, the common section 400 includes a plurality (two or more) of software modules for providing information related to ECPs and Hospitals. In the embodiment shown in FIG. 4, the common section 400 includes seven (7) software modules. In this embodiment, the common section 400 includes two search and compare modules, an ECP search and compare module 402, and a hospital search and compare software module 404. The ECP search and compare module 402 and the hospital search and compare module 404 may each include an interface or form for receiving at least one search criteria for filtering through extended care provider or hospital facility information. In another embodiment, a single interface or form may be used for both the ECP search and compare module 402 and hospital search software module 404. In this embodiment, a check box or similar selective option may be used to assist the user in determining which searchable database the user chooses to access. The search criteria may include names, geographic location (address, city, state, country), medical care required (general or specific), services and amenities provided, service and/or facilities currently available, types of insurance and other payment methods accepted, or other search criteria commonly useful for the filtering of information. The information returned by the database may differ between registered ECPs and hospital facilities, and dependent upon whether the ECP or hospital facility is a registered user of the PMS 200. Upon querying the database system 220 via the search criteria, the information queried by the user may be returned and displayed to the user within PMS 200 environment. Meaning, the information displayed will be returned to the user without the need to redirect the user to a source outside of the PMS 200 environment. However, if information is only accessible outside of the PMS 200 environment, the PMS 200 may prompt the user that they are leaving the PMS 200 secured system and visiting an external website having containing the queried information.

As further illustrated in the embodiment of FIG. 4, the common section 400 includes a media software module 406. The media software module 406 may include a digital media player for providing (audibly or visually) information about extended care providers and hospitals. This information may consist of streamed or stored audio, video, animated, or other content. The content may be educational or promotional in nature. The media player software module 406 may include advertisements, news information, or any other useful media highlighting information on extended care providers or hospital facilities. This information may be specific to only paid registered users of the PMS 200. The common section 400 may further include a website linking software module 408 for providing additional access to information about extended care providers, hospital facilities, or the PMS 200 itself. For example, links to social network sites may be provided for marketing and updating the public on the benefits or using the PMS 200 for their extended care needs or for their general knowledge. This additional access may be provided within the PMS 200 environment, or in the alternative the link may direct or redirect users to the extended care provider's or hospital facility's website, or the social networking site itself. Also shown in the embodiment of FIG. 4, the common section 400 includes a comment showcase software module 410 for highlight comments directed to extended care providers or hospital facilities. The comments may include reviews and ratings, or other information related to customer experiences with the extended care providers or hospital facilities. The comment showcase software module 410 may also include visitor comments, useful observations and recommendation pertaining to the PMS 200, in addition to a response section for allowing the reviewed party to respond to the comments. The source of these comments may be collected via an real-time automated system linking the social network sites to the comment showcase software module 410, or via other means known to persons of ordinary skill in the art. The common section 400 may also include a news software module 412. The news software module 412 may include news stories about the PMS 200, the extended care providers and the hospital facilities. The news software module 412 may further include a current news section having recent or real-time news about the providers or facilities, and an archive news section having older news stories which may be useful for determining whether a patient would select an extended care provider or hospital facility for their healthcare needs. EBooks may also be provided via the news software module 412, for providing users additional information about extended care, the PMS 200, ECPs or hospitals. The common section 400 may further include a registration software module 414 for registering customers, ECPs and hospital facilities, thus providing the users access to additional information base on the information provided during registration. Customers that register in the PMS may be able to save their ECP or hospital searches for further comparison or future reference. During registration a unique identifier specific to each registrant may be created. After registering and logging into the PMS 200, additional information may be made available to the registrants within the common section 400, or through a custom user page or profile (not shown) based upon information received by during registration. For example, registered ECPs and hospitals may be directed to the ECP-specific section 500 and hospital-specific section 600 upon logging into the PMS 200. Login options may be available throughout the PMS 200. For example, in one embodiment, the common section 400 may include a login command for the ECP or hospital. In another embodiment, the ECP or hospital may login via a splash login form or a different section on the interactive website 300.

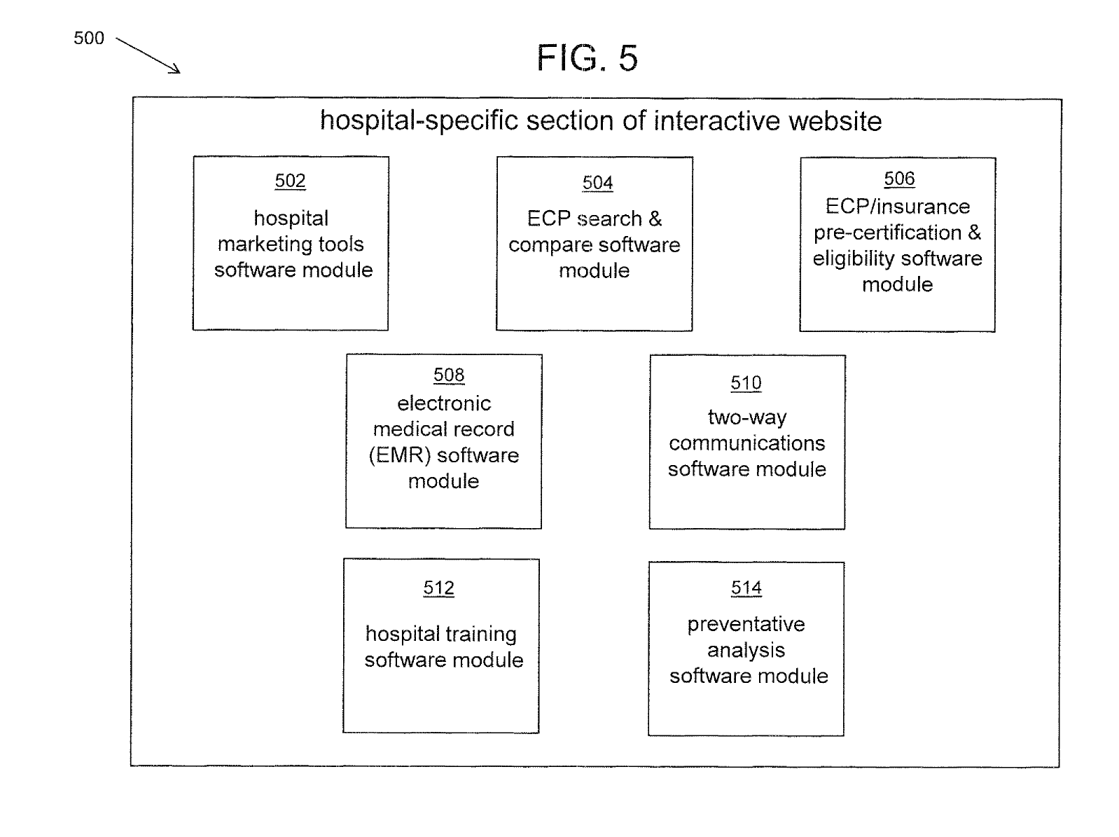

FIG. 5 illustrates a functional block diagram of an embodiment of the hospital-specific section 500 of the interactive website of FIG. 3. Similar to the common section 400, the hospital-specific section 500 may also include computer-executable instructions configured to facilitate the exchange of information between the end user and the PMS 200.

In one embodiment, the hospital-specific section 500 includes a dashboard with plurality of modular components for managing and communicating information with the ECPs. In the embodiment shown in FIG. 5, the hospital-specific section 500 includes a hospital marketing tool software module 502. The hospital marketing tool software module 502 may include multimedia controls for assisting the hospital facility in developing and managing all aspects of its account. In one example, the hospital marketing tool software module 502 may be use by the registered user for creating or uploading information to promote their facility to potential patients or ECPs. In a further embodiment, this information may be highlighted in the common section's 400 media player software module 406, or a similar splash page upon accessing the PMS 200. The hospital-specific section 500 may further include an ECP search and compare module 504. This ECP search and compare software module 504 functions in generally the same fashion as the ECP search and compare software module 402, in that it may include an interface for hospital personnel to input at least one search criteria for filtering through extended care provider information. Additionally, the hospital-specific section 500 includes an ECP/insurance pre-certification and eligibility (PCE) software module 506. The PCE software module 506 may include a patient's medical condition, in addition to insurance information on the patient for identifying which ECPs will be able to accept and service the patients needs. The PCE software module 506 may also be used by the hospital facility to reserve the facility on behalf of a patient to be discharged. As further shown in the embodiment of FIG. 5, the hospital-specific section 500 further includes an electronic medical record (EMR) software module 508. The EMR software module 508 may include input commands for receiving and updating patient information specific to their current treatment or medical history. Examples of various types of patient information that may be provided via the EMR software module 508 include doctors' and nurses' notes, medication information, and a wealth of additional patient medical and treatment information. The EMR software module 508 may also include information to assist the hospital facility in filtering through various ECPs that services a patients particular needs, i.e., provide supplemental search criteria that may not have been queried using the ECP search and compare module 504. For example, ECPs that are able to provide extended monitoring services, based on staffing information provided by the ECP, may be highlighted as a preferred ECP for a patient who requires 24/7 monitoring based on the information provided in the patients EMR. Additionally, the hospital-specific section 500 may include a communication software module 510 for providing two-way communication between the extended care provider and hospital facility. In one embodiment, the communication software module 510 may include a form pre-filled with specific information from the patients EMR. This form may be transmitted through a secured email or to the ECP-specific section 600, as will be discussed below, using the PMS 200. The communication software module 510 may also be used to check availability at a specific ECP. Additionally, the communication software module 510 may also be used to transmit information from the hospital specific section 500 to other sections of the PMS 200. For example, the uploading and transmitting of any marketing materials or a patient's EMR may be communicated using the communications software module 510. The communication software module 510 may be a platform based closed panel communication system, which may enable the hospital end user to send messages or other indicators to an ECP about a potential patient interest. The communication software module 510 may also facilitate the communication between the hospital and ECP users in real-time via an instant messenger channel or the like.

The hospital-specific section 500 may also include a hospital training module 512. The hospital training software module 512 may include forms, media, as well as an FAQ section to assist hospital personnel in learning about the functionality of the PMS 200, and for providing assistance in navigating through the PMS 200. The hospital training software module 512 may also include recertification information for hospital personnel previously trained for utilizing the PMS 200. Use of the hospital training software module 512 may further be used for updating the user on recent changes and new features to the PMS 200. In yet a further embodiment, the hospital-specific section 500 may include a preventative analysis software module 514. The preventative analysis software module 514 is available to assist the hospital facility in analyzing financial transactions for accuracy. For example, the preventative analysis software module 514 may process information pertaining to the patient services provided and the associated costs to manage generate billing statements or other financial statements. The preventative analysis software module 514 may also serves as a final Quality Assurant (QA) tool, to verify the accuracy of the financial information entered by the user into the preventative analysis software module 514.

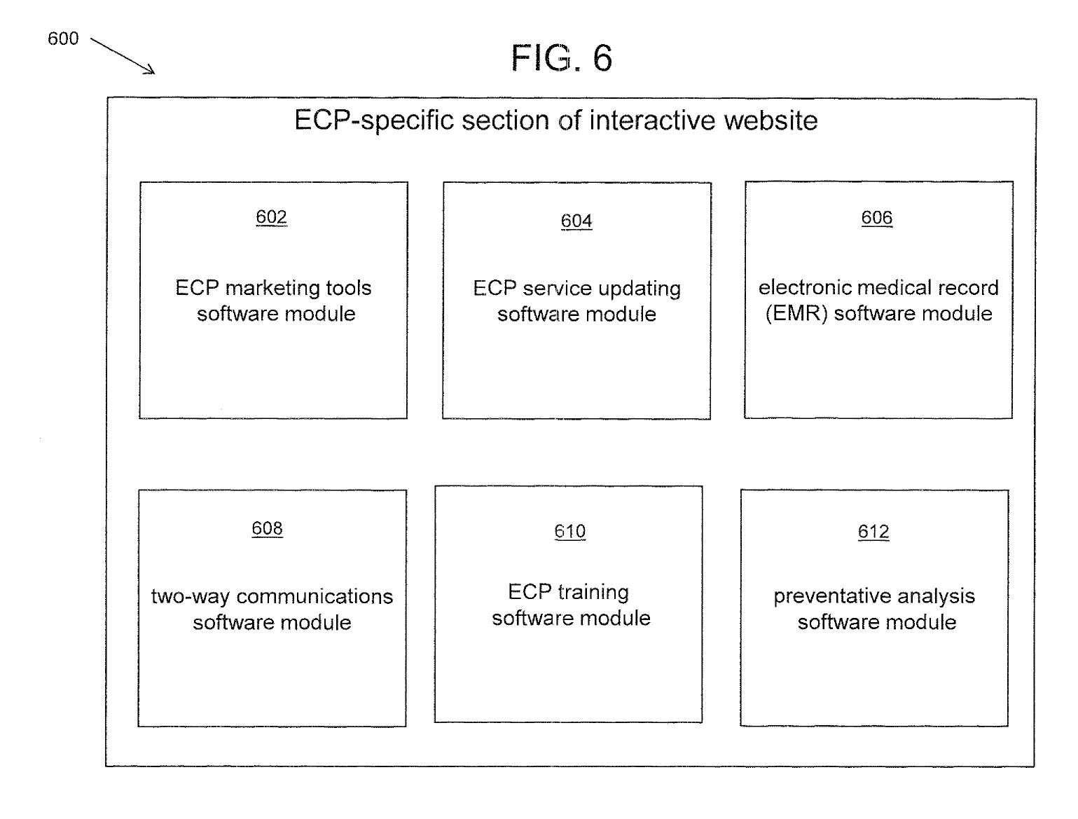

FIG. 6 illustrates a functional block diagram of an embodiment of the ECP-specific section 600 of the interactive website of FIG. 3. Similar to the common section 400 and the hospital-specific section 500, the ECP-specific section 600 may also include computer-executable instructions configured to facilitate the exchange of information between the end user and the PMS 200.

In one embodiment, the ECP-specific section 600 includes a dashboard with plurality of modular components for managing and communicating information with interests parties, i.e., customers and hospitals. In the embodiment shown in FIG. 6, the ECP-specific section 600 includes a ECP marketing tool software module 602. The ECP marketing tool software module 602 is similar to the hospital marketing tool software module 502 in that it may include multimedia controls for assisting the ECP in developing and managing all aspects of its account, for example, creating or uploading information to promote their facility to potential patients or hospital facilities. Additionally, the ECP marketing tool software module 602 may include specific functionality to track visitor traffic e.g., profile hits or requests, for assisting the ECP in evaluating its marketing strategies. In yet a further embodiment, this information may be highlighted in the common section's 400 media player software module 406, or a similar splash page upon accessing the PMS 200. The ECP-specific section 602 may further include an ECP service updating software module 604. This ECP service updating software module 604 functions to provide the types of services the ECP provides along with facility service availability. For example, once a room becomes available at the ECP, the ECP service updating software module 604 may display the room and date availability information to interested persons and hospitals. In one embodiment, the availability information is provided in real-time. Other information that may be provided using the ECP service updating software module 604 includes anticipated availability information. This anticipated availability information may be provided using a calendar system showing the current occupancy schedule for a specific room or a wing of the ECP. In another embodiment, the ECP-specific section 600 may further include an electronic medical record (EMR) software module 606. The EMR software module 606 operates in a manner similar to the EMR software module 508 of the hospital-specific section 500 in that it communicates patient information with the hospital facility. The EMR software module 606 may also include input commands for receiving and updating patient information specific to their current treatment or medical history. In a further embodiment, the ECP-specific section 600 may include a communication software module 608 for providing two-way communication between the extended care provider and hospital facility. Additionally, the communication software module 608 may provide a channel of communication between potential patients and any inquiries they may have for the ECP. The communication software module 608 may function in a similar manner as the communication software module 510 of the hospital-specific section 500; in that it facilitates the communication between the interested parties (i.e., hospitals or customers), in addition to facilitating of the transfer of information between other sections of the PMS 200.

As further shown in the embodiment of FIG. 6, the ECP-specific section 600 may also include an ECP training module 610. The ECP training software module 610 functions in a similar manner to the hospital training software module 512 in that it may include forms, media, as well as an FAQ section to assist ECP personnel with ECP specific operations, in addition to learning about the functionality of the PMS 200, and for providing assistance in navigating through the PMS 200. The ECP training software module 610 may also include recertification information for ECP personnel previously trained on the PMS 200. Use of the ECP training software module 610 may further be used for updating the user on recent changes and new features to the PMS 200 for ECPs. In yet another embodiment, the ECP-specific section 600 may include a preventative analysis software module 612. The preventative analysis software module 612 may also function in a similar manner to the preventative analysis software module 514 in that it is available to assist the ECP in analyzing its financial transactions for accuracy. The preventative analysis software module 612 may also serves as a final Quality Assurant (QA) tool, to verify the accuracy of the financial information entered by the user into the preventative analysis software module 612.

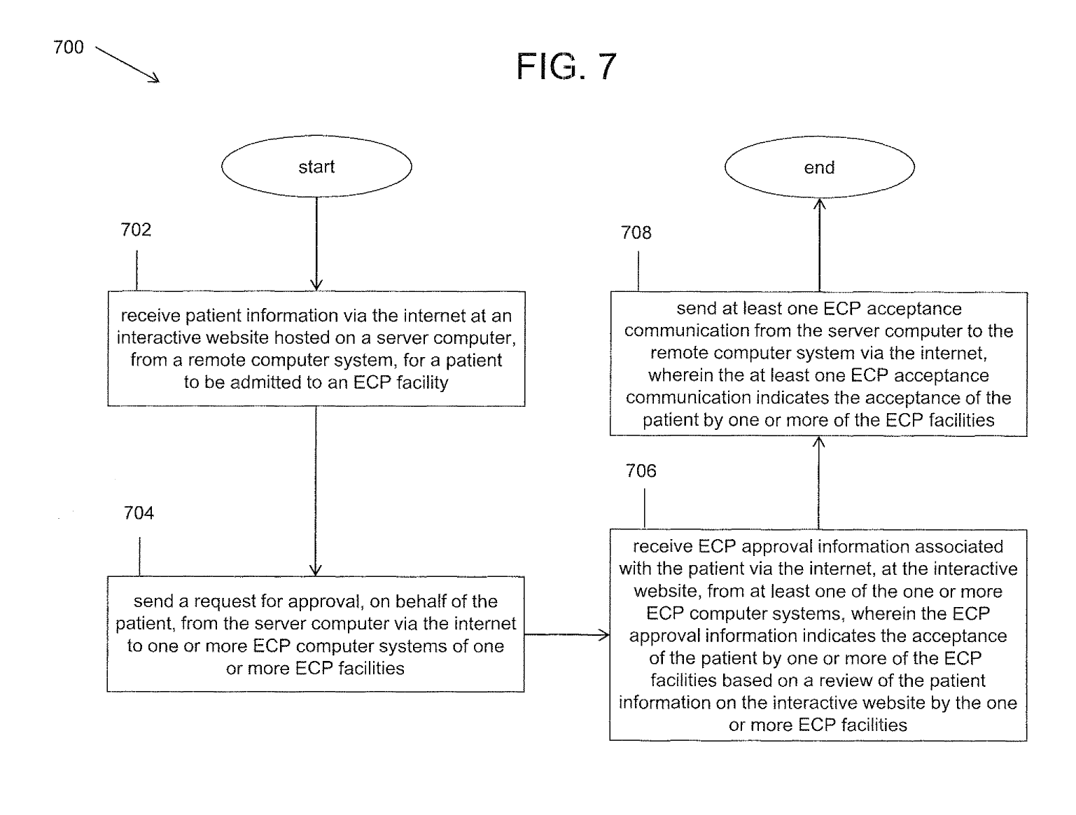

FIG. 7 is a flowchart of a first embodiment of a method 700 to facilitate finding an extended care provider (ECP) for a patient, using the extended-care planning and management system of FIG. 1, from the point of view of the extended-care planning and management system of FIG. 1.

In step 702, the PMS 200 receives patient information via the internet at an interactive website hosted on a server computer, from a remote computer system, for a patient to be admitted to an ECP facility. In step 704, the PMS 200 sends a request for approval, on behalf of the patient, from the server computer via the internet to one or more ECP computer systems of one or more ECP facilities. In step 706, the PMS 200 receives ECP approval information indicating the acceptance of the patient by one or more ECP facilities based on a review of the patient information on the interactive website by one or more ECP facilities. In step 708, the PMS 200 sends at least one ECP acceptance indicating the acceptance of the patient by one or more ECP facilities from the server computer to the remote computer system via the internet.

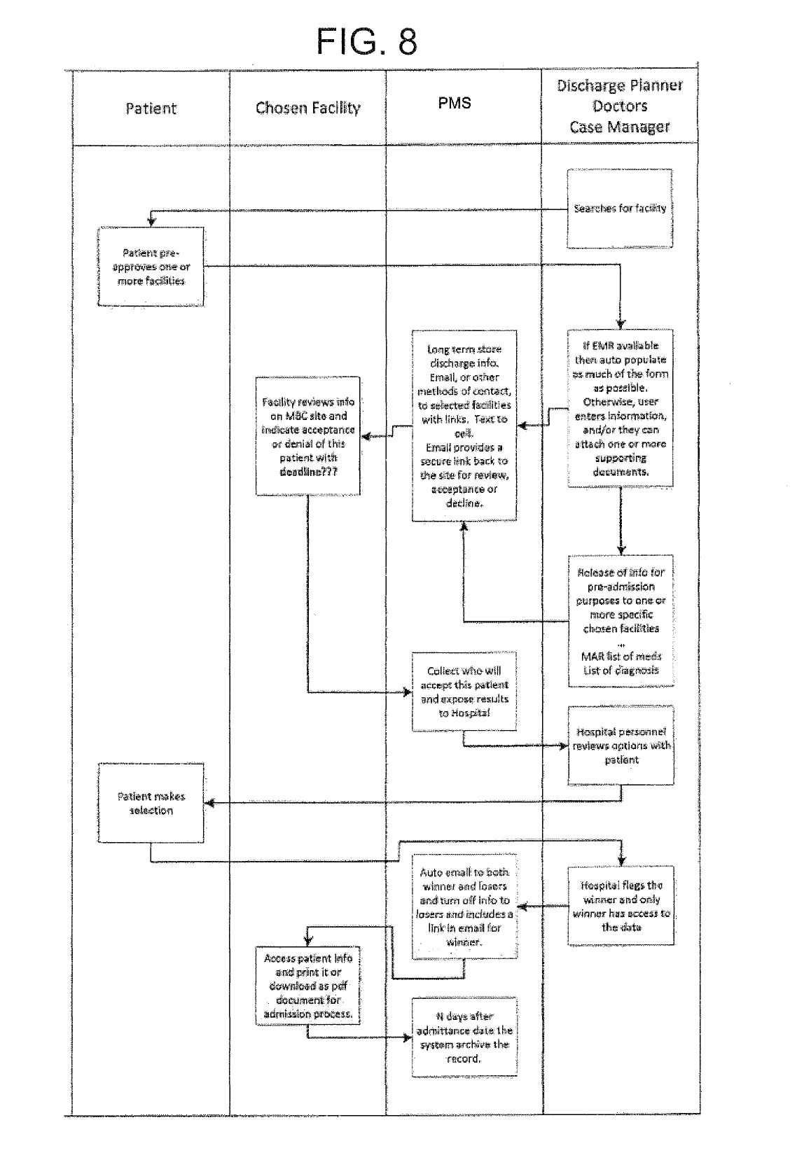

FIG. 8 is a flowchart of a second embodiment of a method 800 to facilitate finding an extended care provider (ECP) for a patient, using the extended-care planning and management system of FIG. 1, from the point of view of a hospital.

The method 800 may begin with the step of receiving an ECP search request, based on ECP search criteria, using the interactive website via the internet from a remote computer system. The method 800 also includes the step of performing a search of at least one searchable database system with searchable listings of ECP facilities, and operatively connected to at least one server computer in response to the ECP search request. The method 800 further includes the step of sending search results, with information corresponding to ECP facilities that match the ECP search criteria, from the server computer to the remote computer system via the internet.

The steps of the method 800 generally allows for the hospital end user to enter patient information, e.g., information from the patient's EMR or pre-admission information, for transmitting the information to possible ECPs. The PMS 200 processes this information, and compares the information to ECPs store in the database system(s) 220. The ECPs review the information and transmits its acceptance or denial of the patient based on this information. The PMS 200 then processes the ECP(s) indicating acceptance of the patient and displays the results to the hospital end user. The hospital end user then reviews the information, possibly with the patient, to determine the patients options. Thereafter, the patient/family member or hospital make a selection as to which ECP will service the patient. The chosen ECP may then be flagged and provided exclusive access to additional information regarding the patient. The PMS 200 may then notify all ECPs of their pending status (selected or not selected to provide service), and transmit the patients additional information to the selected ECP. The ECP will then utilize the PMS 200 for accessing the patient EMR for the admission process.

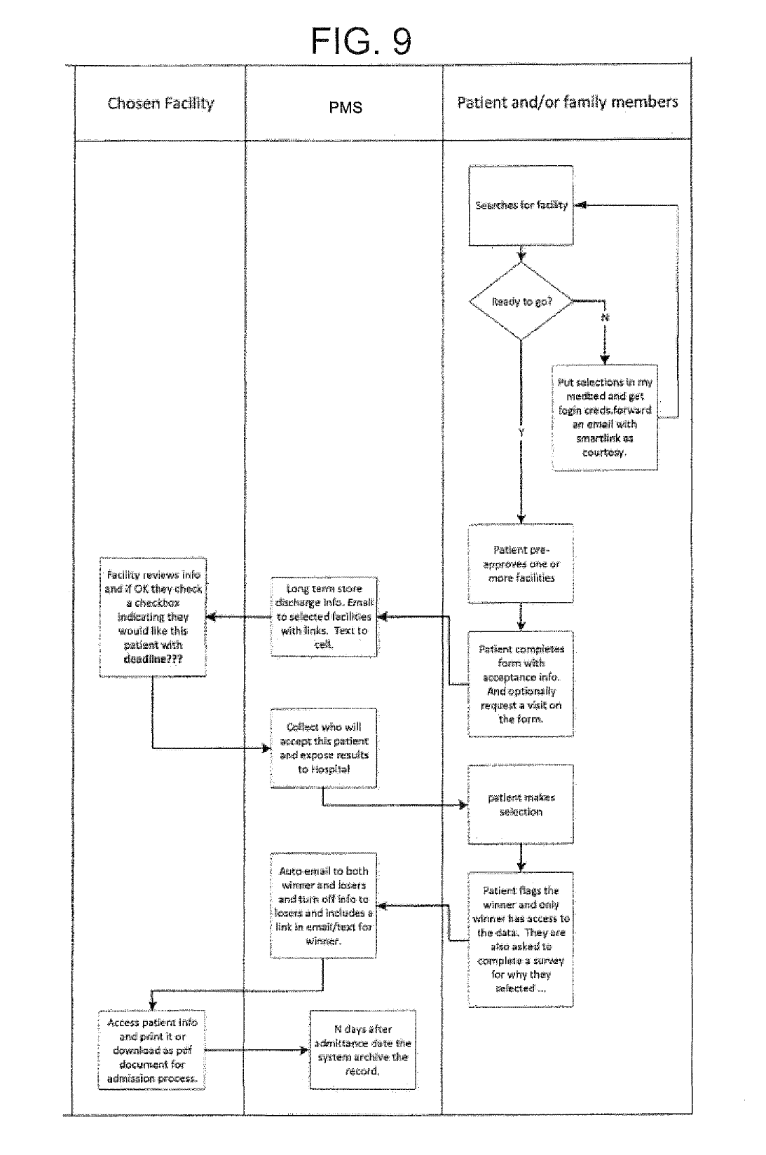

FIG. 9 is a flowchart of a third embodiment of a method 900 to facilitate finding an extended care provider (ECP) for a patient, using the extended-care planning and management system of FIG. 1, from the point of view of a patient.

The steps of method 900 generally allows for interested customers (e.g., patients or their family members/friends) to search for ECP information using the PMS 200. The patient may begin by first entering select criteria specific to their needs or desires of a specific ECP. The information is received by the PMS 200, and displays one or more facilities meeting the select criteria. The patient may then pre-approve, or approve one more ECPs by selecting an acceptance command on a form displayed to the patient, or by other means of receiving acceptance known to persons of ordinary skill in the art, e.g., a check box, or voice input etc. The patient may also request to visit the accepted facility. The PMS 200 then processes the patients acceptance, and transmits the acceptance to the selected ECPs. The information transmitted to the ECPs may include patient contact information e.g., cell phone, address etc., in addition to select information on the patients needs. The ECP will then review the information and if the ECP approves and wishes to admit this patient, the ECP transmits, and the PMS 200 receives this approval and processes the results to the patient, or the hospital facility. In the instance where there are multiple ECPs which accept, the patient may then make a final selection, at which time the final (selected) ECP may then be flagged and provided exclusive access to additional information regarding the patient. The PMS 200 may then notify all ECPs of their pending status (selected or not selected to provide service), and transmit the patients additional information to the selected ECP. The ECP will then utilize the PMS 200 for accessing the patient EMR for the admission process. Thereafter, a record of this transaction will then be archived by the PMS 200 for possible subsequent access.

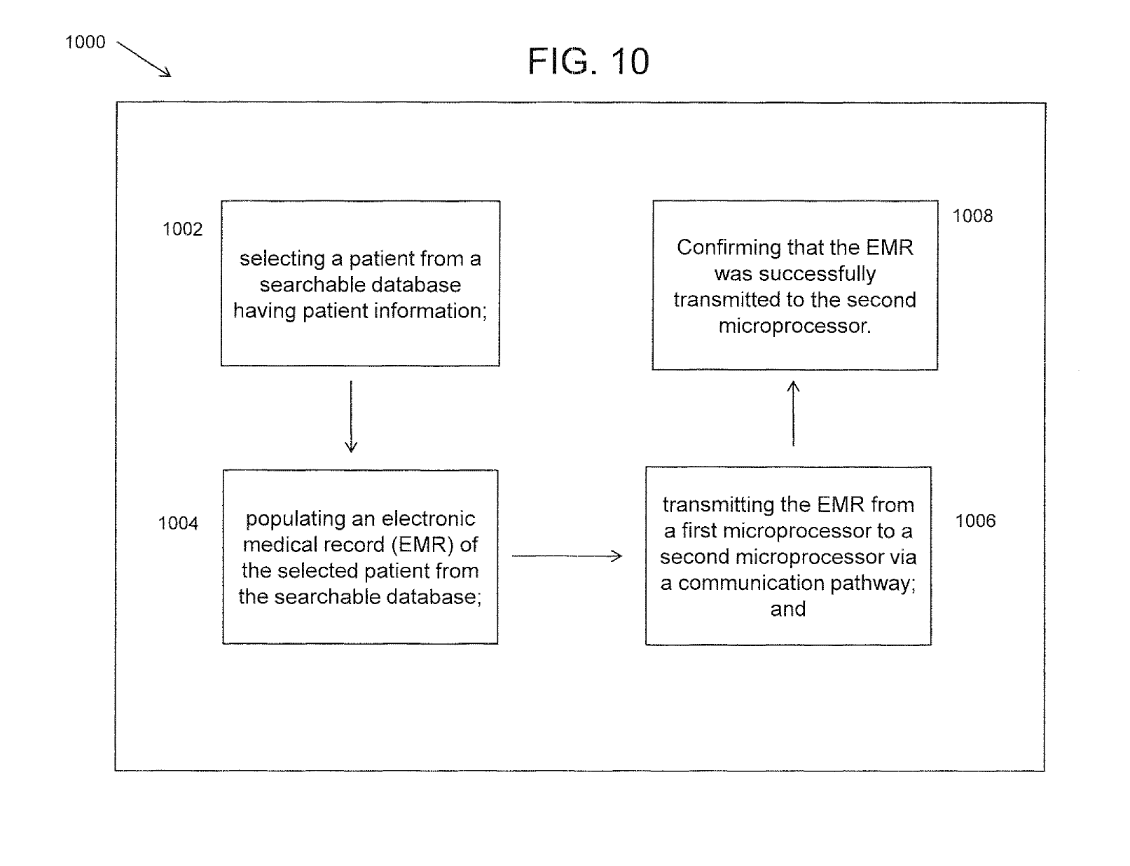

FIG. 10 is a flowchart of an embodiment of a method 1000 to facilitate the exchange of patient information between a hospital and an extended care provider (ECP).

The steps of method 1000 generally allows for the hospitals and ECPs to securely exchange electronic medical records (EMRs) through a secure communication path using a computer or other device capable of transmitting EMRs. This exchange may be initiated (i.e., sent or requested) by either the hospital or the ECP in real-time, thereby reflecting the most up-to-date EMR information for a particular patient. In step 1002, the initiating party selects a particular patient from a listing which may be reflective of patient information gathered from a searchable database. After selecting the patient, in step 1004, the patient's EMR is populated on a first device. At this time, the initiating person may update the EMR with information related to the patient's current condition, treatment or needs, or in the alternative correct any errors found in the EMR. After confirming that the EMR is reflective of the selected patient, and that the information is correct, in step 1006, the EMR is transmitted from the first device to a second device through a secure communication pathway or portal. The secure communication pathway may be representative of a secured infrared connection, Bluetooth, a local or wide area network, or any other means known or accepted by person of skill in the art. In step 1008, the successful transmission of the EMR is confirmed. In one embodiment, the first device generates a confirmation that the EMR was successfully transmitted and may close the secured connection with the second device. In another embodiment, the confirmation may be generated from the second device, or a third monitoring device operatively communicating with either the first device, the second device, or the communication pathway.

In summary, systems, methods, and non-transitory computer-readable media for facilitating extended care planning and management for patients are disclosed. An interactive website is hosted on a server computer, where the interactive website provides a shared or common section being accessible to customers (e.g., patients or other interested parties), hospitals, and extended care providers, a hospital-specific section being accessible to hospitals registered to the system, and an extended care provider (ECP)-specific section being accessible to registered ECP providers. A searchable database is operatively connected to the server computer. The database stores searchable listings of hospitals and ECPs which may be searched via the interactive website by users. The various sections of the website provide interactive capabilities, allowing various types of users of the website to become informed and to subsequently plan and manage the care they need or provide.

It should be appreciated that the steps of the method embodiments described herein are for exemplary purposes, and are not required to be performed in a particular sequence.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. An internet-accessible system for facilitating extended care planning and management for patients, said system comprising:
at least one server computer;
an interactive website hosted on said at least one server computer, wherein said interactive website includes:
a shared section being accessible to customers, hospitals, and extended care providers,
a hospital section being accessible to hospitals registered to said system, and
an extended care provider (ECP) section being accessible to extended care providers (ECPs) registered to said system; and
at least one searchable database operatively connected to said at least one server computer and storing searchable listings of hospitals and extended care providers (ECPs).

2. The system of claim 1 wherein said shared section includes computer-executable instructions configured to facilitate the searching and comparing of entities selected from the group consisting of ECPs and hospitals via the internet.

3. The system of claim 1 wherein said shared section includes computer-executable instructions configured to facilitate the playing of digital media stored on said system via the internet.

4. The system of claim 1 wherein said shared section includes computer-executable instructions configured to facilitate linking to other determined websites via the internet.

5. The system of claim 1 wherein said shared section includes computer-executable instructions configured to facilitate the showcasing of comments of visitors to the interactive website via the internet.

6. The system of claim 1 wherein said shared section includes computer-executable instructions configured to provide access to news stories stored on the system via the internet.

7. The system of claim 1 wherein said hospital section includes computer-executable instructions configured to facilitate the creation of a hospital provider profile, via the internet, which can be accessed by visitors to the interactive website.

8. The system of claim 1 wherein said hospital section includes computer-executable instructions configured to facilitate the searching and comparing of ECPs via the internet.

9. The system of claim 1 wherein said hospital section includes computer-executable instructions configured to facilitate:
the pre-certifying of patient medical conditions and insurance eligibility with one or more ECPs via the internet;
determining the availability of services and facilities at one or more ECPs via the internet; and
scheduling services and reserving facilities at a selected ECP via the internet.

10. The system of claim 1 wherein said hospital section includes computer-executable instructions configured to facilitate the assembling and editing of patient electronic medical record (EMR) information and to facilitate secure, real-time transmission of the patient EMR information between a hospital computer and an ECP computer via the internet.

11. The system of claim 1 wherein said hospital section includes computer-executable instructions configured to facilitate the two-way communication of electronic notifications and information between a hospital computer and an ECP computer via the internet.

12. The system of claim 1 wherein said hospital section includes computer-executable instructions configured to facilitate the training of a hospital discharge planner via the internet.

13. The system of claim 1 wherein said ECP section includes computer-executable instructions configured to facilitate the creation of an ECP provider profile, via the internet, which can be accessed by visitors to the interactive website.

14. The system of claim 1 wherein said ECP section includes computer-executable instructions configured to facilitate the updating of available facility openings and care and service offerings of an ECP via the internet.

15. The system of claim 1 wherein said ECP section includes computer-executable instructions configured to facilitate the assembling and editing of patient electronic medical record (EMR) information and to facilitate secure, real-time transmission of the patient EMR information between an ECP computer and a hospital computer via the internet.

16. The system of claim 1 wherein said ECP section includes computer-executable instructions configured to facilitate the two-way communication of electronic notifications and information between an ECP computer and a hospital computer via the internet.

17. The system of claim 1 wherein said ECP section includes computer-executable instructions configured to facilitate the training of ECP admissions coordinators and marketing personnel via the internet.

18. A non-transitory computer-readable medium having computer-executable instructions recorded thereon and capable of being executed by an internet-accessible server computer hosting an interactive website to facilitate extended care planning and management for patients, said instructions comprising:
instructions for the pre-certifying of patient medical conditions and insurance eligibility with one or more extended care providers (ECPs) via the internet;
instructions for determining the availability of services and facilities at one or more ECPs via the internet; and
instructions for scheduling services and reserving facilities at a selected ECP via the internet.

19. The non-transitory computer-readable medium of claim 18 wherein said instructions further comprise:
instructions for facilitating the searching and comparing of ECPs via the internet; and
instructions for facilitating the searching and comparing of hospitals via the internet.

20. The non-transitory computer-readable medium of claim 18 wherein said instructions further comprise:
instructions for facilitating the creation of a hospital provider profile, via the internet, which can be accessed by visitors to the interactive website; and
instructions for facilitating the creation of an extended care provider profile, via the internet, which can be accessed by visitors to the interactive website.

21. The non-transitory computer-readable medium of claim 18 wherein said instructions further comprise instructions for facilitating the assembling and editing of patient electronic medical record (EMR) information and for facilitating secure, real-time transmission of the patient EMR information between a hospital computer and an ECP computer via the internet.

22. The non-transitory computer-readable medium of claim 18 wherein said instructions further comprise instructions for facilitating the training of at least one user selected from the group consisting of hospital discharge planners, ECP admissions coordinators, and marketing personnel via the internet.

23. A method to facilitate finding an extended care provider (ECP) for a patient, said method comprising:
receiving patient information via the internet at an interactive website hosted on a server computer, from a remote computer system, for a patient to be admitted to an ECP facility;
sending a request for approval, on behalf of the patient, from the server computer via the internet to one or more ECP computer systems of one or more ECP facilities;
receiving ECP approval information associated with said patient via the internet, at said interactive website, from at least one of said one or more ECP computer systems, wherein said ECP approval information indicates the acceptance of said patient by one or more of said ECP facilities based on a review of said patient information on said interactive website by said one or more ECP facilities; and
sending at least one ECP acceptance communication from said server computer to said remote computer system via the internet, wherein said at least one ECP acceptance communication indicates the acceptance of said patient by one or more of said ECP facilities.

24. The method of claim 23 further comprising receiving patient acceptance information at said interactive website via the internet, corresponding to one of said ECP facilities, from said remote computer system, wherein said patient acceptance information indicates the acceptance of one of said ECP facilities by said patient.

25. The method of claim 24 further comprising sending a patient acceptance communication from said server computer to said one or more ECP computer systems via the internet, wherein said patient acceptance communication indicates the acceptance of an ECP facility by said patient.

26. The method of claim 23 wherein said patient information is selected from the group consisting of information extracted from an electronic medical record (EMR) of said patient and information identifying one or more ECP facilities selected by said patient.

27. The method of claim 23 further comprising receiving an ECP search request, having ECP search criteria, at said interactive website via the internet from said remote computer system.

28. The method of claim 27 further comprising performing a search of at least one searchable database operatively connected to said at least one server computer in response to said ECP search request, wherein said at least one searchable database stores searchable listings of ECP facilities.

29. The method of claim 28 further comprising sending search results from said server computer to said remote computer system via the internet, wherein said search results include information corresponding to ECP facilities that match said ECP search criteria.

30. The method of claim 23 wherein said remote computer system is selected from the group consisting of a hospital computer system located at a hospital and a patient computer system.

31. A non-transitory computer-readable medium having computer-executable instructions recorded thereon and capable of being executed by an internet-accessible server computer hosting an interactive website to facilitate finding an extended care provider (ECP) for a patient, said instructions comprising:
instructions for receiving patient information via the internet at an interactive website hosted on a server computer, from a remote computer system, for a patient to be admitted to an ECP facility;
instructions for sending a request for approval, on behalf of the patient, from the server computer via the internet to one or more ECP computer systems of one or more ECP facilities;
instructions for receiving ECP approval information associated with said patient via the interne, at said interactive website, from at least one of said one or more ECP computer systems, wherein said ECP approval information indicates the acceptance of said patient by one or more of said ECP facilities based on a review of said patient information on said interactive website by said one or more ECP facilities; and
instructions for sending at least one ECP acceptance communication from said server computer to said remote computer system via the internet, wherein said at least one ECP acceptance communication indicates the acceptance of said patient by one or more of said ECP facilities.

32. The non-transitory computer-readable medium of claim 31 wherein said instructions further comprise instructions for receiving patient acceptance information at said interactive website via the internet, corresponding to one of said ECP facilities, from said remote computer system, wherein said patient acceptance information indicates the acceptance of one of said ECP facilities by said patient.

33. The non-transitory computer-readable medium of claim 32 wherein said instructions further comprise instructions for sending a patient acceptance communication from said server computer to said one or more ECP computer systems via the internet, wherein said patient acceptance communication indicates the acceptance of an ECP facility by said patient.

34. The non-transitory computer-readable medium of claim 31 wherein said instructions further comprise instructions for receiving an ECP search request, having ECP search criteria, at said interactive website via the internet from said remote computer system.

35. The non-transitory computer-readable medium of claim 34 wherein said instructions further comprise instructions for performing a search of at least one searchable database operatively connected to said server computer in response to said ECP search request, wherein said at least one searchable database stores searchable listings of ECP facilities.

36. The non-transitory computer-readable medium of claim 35 wherein said instructions further comprise instructions for sending search results from said server computer to said remote computer system via the internet, wherein said search results include information corresponding to ECP facilities that match said ECP search criteria.

37. A system to facilitate the generation of revenue via an interactive website, said system comprising:
an interactive website hosted on at least one server computer and maintained by a service provider, wherein said interactive website is configured to link patients and hospital entities to extended care provider (ECP) entities;
means for facilitating the development and hosting of a multimedia ECP profile on said interactive website by a registered ECP entity in exchange for a fee to be paid by said registered ECP entity to said service provider in accordance with a first determined fee arrangement; and
means for facilitating the development and hosting of a multimedia hospital profile on said interactive website by a registered hospital entity in exchange for a fee to be paid by said registered hospital entity to said service provider in accordance with a determined second fee arrangement.

38. The system of claim 37 further comprising
means for registering an ECP entity as a member of said interactive website and configuring said interactive website to be accessed by said registered ECP entity in exchange for a fee to be paid by said ECP entity to said service provider in accordance with a determined third fee arrangement; and
means for registering a hospital entity as a member of said interactive website and configuring said interactive website to be accessed by said registered hospital entity in exchange for a fee to be paid by said hospital entity to said service provider in accordance with a determined fourth fee arrangement.

39. The system of claim 37 further comprising:
means for facilitating the assembling and editing of patient electronic medical record (EMR) information by a third party using the interactive website; and
means for facilitating the secure, real-time transmission of the patient EMR information to the third party,
in exchange for a fee to be paid by said third party to said service provider in accordance with a determined third fee arrangement.

40. The system of claim 37 further comprising:
means for performing a preventative analysis for a registered ECP entity in exchange for a fee to be paid by said ECP entity to said service provider in accordance with a determined third fee arrangement, wherein said preventative analysis identifies at least one of improper charges to patients by said ECP entity, duplicate payments by patients to said ECP entity, mistakes by fiscal intermediaries on behalf of patients of said ECP entity, and medical necessity and coding errors of patients of said ECP entity; and
means for performing a preventative analysis for a registered hospital entity in exchange for a fee to be paid by said hospital entity to said service provider in accordance with a determined fourth fee arrangement, wherein said preventative analysis identifies at least one of improper charges to patients by said hospital entity, duplicate payments by patients to said hospital entity, mistakes by fiscal intermediaries on behalf of patients of said hospital entity, and medical necessity and coding errors of patients of said hospital entity.

41. The system of claim 37 further comprising means for posting an advertisement of an advertising entity to said interactive website in exchange for a fee to be paid by said advertising entity to said service provider in accordance with a determined third fee arrangement.

42. A non-transitory computer-readable medium having computer-executable instructions recorded thereon and capable of being executed by an internet-accessible server computer hosting an interactive website to facilitate the generation of revenue via the interactive website, said instructions comprising:
instructions for facilitating the development and hosting of a multimedia ECP profile on said interactive website by a registered ECP entity of said interactive website in exchange for a fee to be paid by said registered ECP entity to a service provider of said website in accordance with a first determined fee arrangement; and
instructions for facilitating the development and hosting of a multimedia hospital profile on said interactive website by a registered hospital entity of said interactive website in exchange for a fee to be paid by said registered hospital entity to said service provider of said website in accordance with a second determined fee arrangement.

43. The non-transitory computer-readable medium of claim 42 wherein said instructions further comprise:
instructions for registering an ECP entity as a member of said interactive website and configuring said interactive website to be accessed by said registered ECP entity in exchange for a fee to be paid by said ECP entity to said service provider in accordance with a determined third fee arrangement; and
instructions for registering a hospital entity as a member of said interactive website and configuring said interactive website to be accessed by said registered hospital entity in exchange for a fee to be paid by said hospital entity to said service provider in accordance with a determined fourth fee arrangement.

44. The non-transitory computer-readable medium of claim 42 wherein said instructions further comprise instructions for:
facilitating the assembling and editing of patient electronic medical record (EMR) information by a third party using the interactive website; and
facilitating the secure, real-time transmission of the patient EMR information to the third party,
in exchange for a fee to be paid by said third party to said service provider in accordance with a determined third fee arrangement.

45. The non-transitory computer-readable medium of claim 42 wherein said instructions further comprise:
instructions for performing a preventative analysis for a registered ECP entity in exchange for a fee to be paid by said ECP entity to said service provider in accordance with a determined third fee arrangement, wherein said preventative analysis identifies at least one of improper charges to patients by said ECP entity, duplicate payments by patients to said ECP entity, mistakes by fiscal intermediaries on behalf of patients of said ECP entity, and medical necessity and coding errors of patients of said ECP entity; and
instructions for performing a preventative analysis for a registered hospital entity in exchange for a fee to be paid by said hospital entity to said service provider in accordance with a determined fourth fee arrangement, wherein said preventative analysis identifies at least one of improper charges to patients by said hospital entity, duplicate payments by patients to said hospital entity, mistakes by fiscal intermediaries on behalf of patients of said hospital entity, and medical necessity and coding errors of patients of said hospital entity.

46. A non-transitory computer-readable medium having computer-executable instructions recorded thereon for facilitating the exchange of information between a hospital and an extended care provider (ECP) said instructions comprising:
selecting a patient from a searchable database having patient information store thereon;
populating an electronic medical record (EMR) of said selected patient from said searchable database; and
transmitting said EMR from a first microprocessor to a second microprocessor via a communication pathway.
